(19) United States
(12) Patent Application Publication
(10) Pub. No.: US 2022/0339821 A1
(43) Pub. Date: Oct. 27, 2022

(54) METHOD FOR PRODUCING MULTIPLE PREFORM AND SYNTHETIC RESIN CONTAINER

(71) Applicant: TOYO SEIKAN CO., LTD., Tokyo (JP)

(72) Inventors: Hiromitsu KIYOTO, Yokohama-shi, Kanagawa (JP); Haijime INAGAKI, Shinagawa-ku, Tokyo (JP); Hideto MONZEN, Yokohama-shi, Kanagawa (JP); Hiroki YASUKAWA, Yokohama-shi, Kanagawa (JP)

(73) Assignee: TOYO SEIKAN CO., LTD., Tokyo (JP)

(21) Appl. No.: 17/765,121

(22) PCT Filed: Sep. 25, 2020
(86) PCT No.: PCT/JP2020/036235

§ 371 Date: Mar. 30, 2022

(30) Foreign Application Priority Data
Oct. 1, 2019 (JP) 2019-181646

(51) Int. Cl. B29B 11/08; B65D 1/02; B29C 49/06

(52) U.S. Cl. CPC B29B 11/08; B65D 1/0215; B65D 1/023; B29C 49/06; B29C 2949/3034; B29C 2949/077; B29K 2101/12

(57) ABSTRACT

A method for producing a multiple preform, including a primary injection for injection molding a preform main body using a primary mold, and a secondary injection for injection molding, using a secondary mold, a covering layer that covers the preform main body such that the terminal end side of the covering layer covers the lower surface of the neck ring and reaches the peripheral edge of the neck ring. A projection strip portion is formed when the preform main body is inserted into the secondary mold to be clamped, that projects in a gap in which the covering layer is molded to be in contact with or adjacent to a lower surface of the neck ring, and that extends with a given length along an axis direction, is formed on an inner peripheral surface of the secondary molding mold, thereby forming an easy tear portion in the covering layer.

### TECHNICAL FIELD

The present invention relates to a method for producing a multiple preform and a synthetic resin container.

### BACKGROUND ART

Conventionally, as a beverage container with any kind of beverage therein as contents, there is known a synthetic resin container produced by forming a preform using synthetic resin such as polyethylene terephthalate and then molding this preform into a bottle shape by stretch blow molding or the like (see Patent Literature 1, for example).

To provide this kind of container with a function such as a light-blocking property, changing the material constituting the container main body can be considered. However, considering the recyclability of the bottle, the requirements for the material are strict, and there is a limit for achieving a desired function by changing the material of the container main body.

Thus, recently, consideration has been given to that the whole container except a part of the mouth portion side where a cap is attached is formed as a multi-layer container in which the outer surface of the container main body is covered with a covering layer having a specific function or characteristic, thereby providing the container with various functions and characteristics (Patent Literature 2).

Such a container can be manufactured by blow molding a multiple preform having a plurality of layers, and allows recycling of a plastic container main body (PET bottle) by separating and removing the covering layer from the container main body in the same manner as a label conventionally attached around a body portion of a bottle.

### CITATION LIST

### Patent Literature

Patent Literature 1: JP 2007-230579 A

Patent Literature 2: JP 2015-128858 A

### SUMMARY OF INVENTION

### Technical Problem

However, if the whole container except a part of the mouth portion side is covered with a covering layer, an edge serving as a start point for picking and tearing off by hand is small, and when the multiple preform with a plurality of layers is blow-molded into a container shape, the covering layer after molding becomes partially thick depending on the shape of the container, for example, whereby it is not easy to separate and remove the covering layer from the container main body.

The present invention has been made in view of such an aspect, and aims at providing a method for producing a multiple preform for producing a synthetic resin container and providing the synthetic resin container in which the synthetic resin container has a covering layer which covers the whole container except a part of the mouth portion side and is formed on the surface of the container main body, and allowing the covering layer to be easily separated from the container main body after use.

### Solution to Problem

A method for producing a multiple preform according to the present invention is a method for producing a multiple preform for blow molding a synthetic resin container with a covering layer, the method comprising a primary injection for injection molding, using a primary molding mold, a preform main body that is formed to have a bottomed cylindrical shape including a mouth portion, a body portion, and a bottom portion, and that includes a neck ring annularly projecting along a circumferential direction on a lower end side of the mouth portion, and a secondary injection for injection molding, using a secondary molding mold, a covering layer that covers the preform main body such that a terminal end side of the covering layer covers a lower surface of the neck ring and reaches a peripheral edge of the neck ring, wherein a projection strip portion that is formed between the preform main body and an inner peripheral surface of the secondary molding mold when the preform main body molded in the primary injection is inserted into the secondary mold to be clamped, that projects in a gap in which the covering layer is molded to be in contact with or adjacent to a lower surface of the neck ring, and that extends with a given length along an axis direction, is formed on an inner peripheral surface of the secondary molding mold, thereby forming an easy tear portion in the covering layer molded in the secondary injection.

Moreover, a synthetic resin container according to the present invention is configured to comprise a mouth portion, a body portion, and a bottom portion, wherein the synthetic resin container includes a neck ring that annularly projects along a circumferential direction on a lower end side of the mouth portion, and a covering layer that covers a region except a part of the mouth portion side such that a terminal end side of the covering layer covers a lower surface of the neck ring and reaches a peripheral edge of the neck ring, and an easy tear-off portion extending along an axis direction is formed in a range including the lower surface of the neck ring and a region immediately below the neck ring.

### Advantageous Effects of Invention

In the present invention, when a container of which the contents have been consumed to the end is disposed, the terminal end side of the covering layer in the vicinity of the peripheral edge of the neck ring is picked with fingers to tear off the covering layer along the easy tear portion, whereby it is possible to easily separate the container main body and the covering layer.

### BRIEF DESCRIPTION OF DRAWINGS

FIG. 1 is a front view schematically illustrating a first embodiment of a multiple preform according to the present invention.

FIG. 2 is a bottom view schematically illustrating the first embodiment of the multiple preform according to the present invention.

FIG. 3 is a section view along line A-A of FIG. 2.

FIG. 4 is an explanatory view schematically illustrating a first embodiment of a synthetic resin container according to the present invention.

FIG. 5 is an enlarged end view of main part illustrating, in an enlarged manner, a range surrounded by a dashed line of FIG. 4, regarding the first embodiment of the synthetic resin container according to the present invention.

FIG. 6 is an explanatory view schematically illustrating a production step including a primary injection, regarding an injection molding method for producing the first embodiment of the multiple preform according to the present invention.

FIG. 7 is an explanatory view schematically illustrating a production step including a secondary injection, regarding the injection molding method for producing the first embodiment of the multiple preform according to the present invention.

FIG. 8 is an explanatory view illustrating, in an enlarged manner, a part of a body portion mold illustrated in FIG. 6 regarding a molding mold used for producing a multiple preform according to the present invention, in which (a) is an enlarged perspective view of main part illustrating a perspective view of a parting surface side of the body portion mold, and (b) is an enlarged plan view of main part illustrating the parting surface side of the body portion mold.

FIG. 9 is a front view schematically illustrating a second embodiment of the multiple preform according to the present invention.

FIG. 10 is a bottom view schematically illustrating the second embodiment of the multiple preform according to the present invention.

FIG. 11 is a section view along line B-B of FIG. 10.

FIG. 12 is an explanatory view schematically illustrating a production step including a primary injection, regarding an injection molding method for producing the second embodiment of the multiple preform according to the present invention.

FIG. 13 is an explanatory view schematically illustrating a production step including a secondary injection, regarding the injection molding method for producing the second embodiment of the multiple preform according to the present invention.

FIG. 14 is a perspective view schematically illustrating a third embodiment of the multiple preform according to the present invention.

FIG. 15 is a perspective view schematically illustrating a third embodiment of the synthetic resin container according to the present invention.

FIG. 16 is an enlarged end view of main part schematically illustrating a fourth embodiment of the synthetic resin container according to the present invention.

### DESCRIPTION OF EMBODIMENTS

The following describes preferred embodiments of the present invention with reference to the drawings.

### First Embodiment

First, the first embodiment of the present invention will be described.

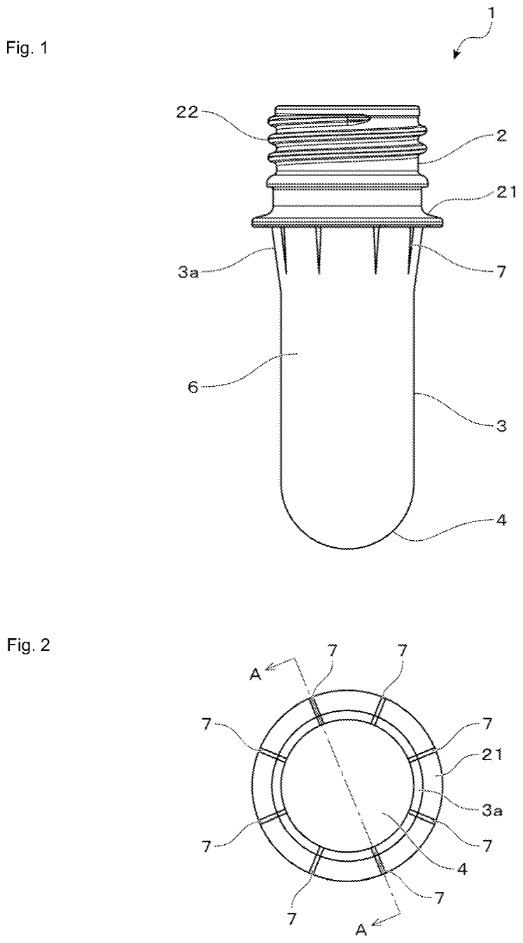

FIG. 1 is an explanatory view schematically illustrating a multiple preform 1 according to the present embodiment, and the multiple preform 1 illustrated in FIG. 1 comprises a mouth portion 2, a body portion 3, and a bottom portion 4.

FIG. 2 is a bottom view schematically illustrating the first embodiment of the multiple preform according to the present invention.

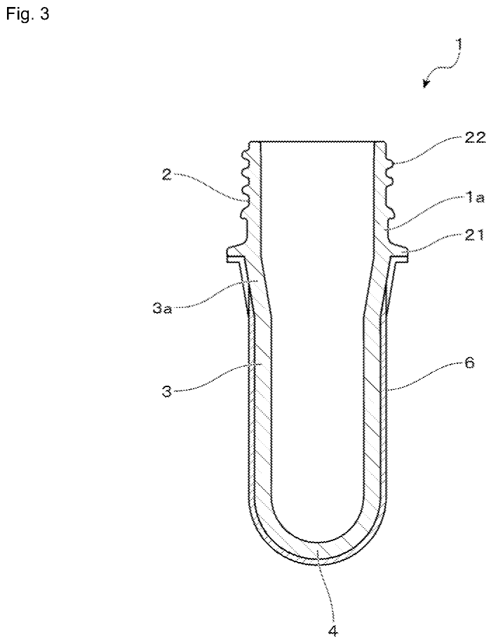

FIG. 3 is a section view along line A-A of FIG. 2.

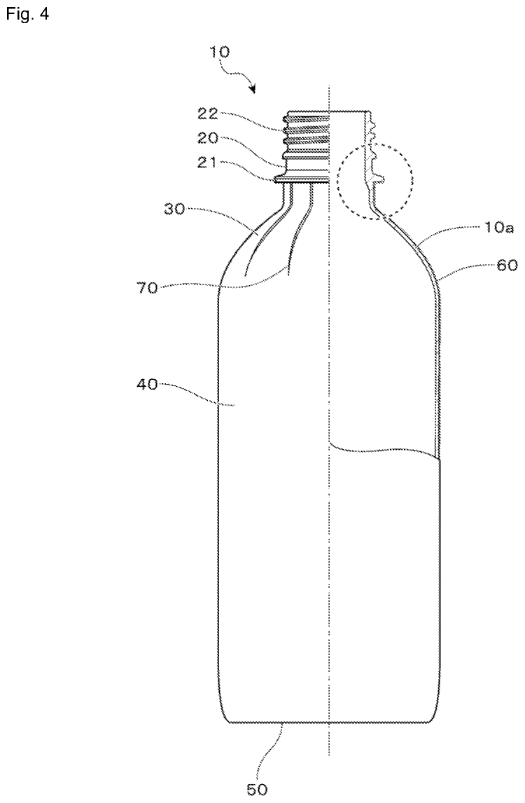

FIG. 4 is an explanatory view illustrating an example of a synthetic resin container 10 produced by blow molding the multiple preform 1 illustrated in FIG. 1, in which a part of the synthetic resin container 10 is cut away. The container 10 illustrated in FIG. 4 comprises a mouth portion 20, a shoulder portion 30, a body portion 40, and a bottom portion 50, and also includes a covering layer 60 covering the surface of a container main body 10a except a part of the mouth portion 20 side.

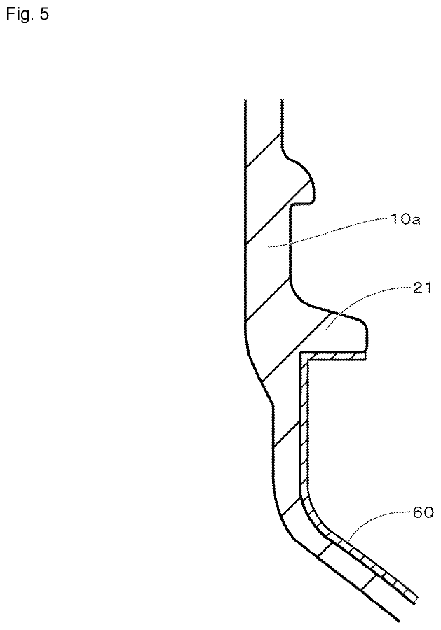

Note that FIG. 5 illustrates, in an enlarged manner, a range surrounded by a dashed line in FIG. 4.

In the present embodiment, the multiple preform 1 includes a bottomed cylindrical preform main body 1a with one opening end side as the mouth portion 2, and a covering layer 6 covering the preform main body 1a except a part of the mouth portion 2 side, and the other end side of the preform main body 1a is closed by the bottom portion 4 formed to have a hemispherical shape.

The mouth portion 2 of the multiple preform 1 is a region to be used as is as the mouth portion 20 of the container 10 without being stretched by blow molding, and a screw thread 22 for attaching a cap (not illustrated) is provided on the outer peripheral surface of the mouth portion 2.

Moreover, on the lower end side of the mouth portion 2, there is provided a neck ring 21 annularly projecting along the circumferential direction.

The multiple preform 1 is set in a blow molding mold (not illustrated), and a region from a portion immediately below the mouth portion 2 to the bottom portion 4 is stretched in an axis direction (vertical direction) by using a stretch rod if necessary, and is simultaneously stretched in an axis direction and a circumferential direction (horizontal direction) by blow air blown into the multiple preform 1. Then, the inner surface shape of the blow molding mold is transferred to the stretched region, thereby molding the container 10 to have a desired container shape.

Here, in the present embodiment, it is supposed that the upper, lower, right, left, vertical, and horizontal directions of the multiple preform 1 are defined in the state illustrated in FIG. 1 where the mouth portion 2 is on the upper side. Similarly, it is supposed that the upper, lower, right, left, vertical, and horizontal directions of the container 10 are also defined in the state illustrated in FIG. 4 where the container 10 stands upright with the mouth portion 20 on the upper side.

In blow molding the multiple preform 1 in the above-described manner, the container main body 10a is formed by the stretched preform main body 1a, and the covering layer 6 covering the preform main body 1a is stretched integrally with the preform main body 1a to form the covering layer 60 covering the surface of the container main body 10a.

In this case, the covering layer 6 stretched integrally with the preform main body 1 a closely contacts with the inner surface of the blow molding mold, and an uneven shape formed on the inner surface of the blow molding mold is transferred to the stretched preform main body 1a through the covering layer 6. As a result, on the surface of the container 10 manufactured by blow molding the multiple preform 1, there is formed the covering layer 60 to which the same uneven shape in accordance with the uneven shape on the surface of the container main body 10a is transferred.

Moreover, the covering layer 6 of the multiple preform 1 is provided to cover the preform main body 1a except a part of the mouth portion 2 side. In the present embodiment, however, the covering layer 6 is provided so as to cover a region from the immediately below the mouth portion 2 to the bottom portion 4, that is, the region stretched by blow molding, and so as to cover, with the terminal end side of the covering layer 6, the lower surface of the neck ring 21 provided on the lower end side of the mouth portion 2 and reach the peripheral edge of the neck ring 21.

In blow molding the multiple preform 1, the mouth portion 2 including the neck ring 21 becomes the mouth portion 20 of the container 10 as is without being stretched, and the terminal end side of the covering layer 6 covering the lower surface of the neck ring 21 also remains as is. Thus, when the covering layer 6 of the multiple preform 1 is provided in the above-described manner, the covering layer 60 of the container 10 is similarly provided such that the terminal end side thereof covers the lower surface of the neck ring 21 provided on the lower end side of the mouth portion 20 and reaches the peripheral edge of the neck ring 21.

Moreover, the covering layer 6 of the multiple preform 1 has an easy tear portion 7 extending linearly along the axis direction, in a range including the lower surface of the neck ring 21 and the region immediately below the neck ring 21.

In the illustrated example, the easy tear portion 7 is provided from the edge portion of the neck ring 21 lower surface to a part of the body portion 3 such that the start edge of the easy tear portion 7 is the peripheral edge of the neck ring 21 of the multiple preform 1 and the end edge thereof is located at a position of approximately ⅕ of the length of the body portion 3 from the upper end of the body portion 3. Regarding the position where the easy tear portion 7 is provided, it is preferable to arrange, in the container 10 after blow molding, the easy tear portion 70 from the peripheral edge of the neck ring 21 lower surface to at least the shoulder portion 30 expanding in diameter from the lower part of the container mouth portion 20 toward the body portion 40, and the position is appropriately changed depending on a shape of the container 10.

Moreover, the example in the drawing illustrates the embodiment in which eight easy tear portions 7 are provided with intervals in the circumferential direction. However, the number of the easy tear portions 7 provided and the arrangement positions thereof in the circumferential direction of the multiple preform 1 are appropriately changed depending on a shape of the container 10.

Such an easy tear portion 7 is preferably formed to have a slit shape so as to expose the preform main body 1a (see FIG. 3).

Moreover, the body portion 3 of the multiple preform 1 of the present embodiment has a taper portion 3a expanding in diameter toward the neck ring 21 on the lower side of the neck ring, at least in a vertical area where the easy tear portion 7 is provided. The taper provided in the body portion 3 in this manner exerts the effect of allowing the mold to be opened in the vertical direction without causing an undercut shape when the multiple preform 1 is molded. The detail thereof will be described later.

When the multiple preform 1 is blow-molded, the easy tear portion 70 extending along the axis direction is formed on the lower surface of the neck ring 21 of the container 10 and at a region immediately below the neck ring 21 of the container 10. In the illustrated example, the easy tear portion 70 is provided from the lower surface of the neck ring 21 of the container 10 to the shoulder portion 30 expanding in diameter from the lower part of the container mouth portion 20 toward the body portion 40.

In this manner, when the container 10 of which the contents have been consumed to the end is disposed, a finger is hooked the terminal end of the covering layer 60 which is reaching the peripheral edge of the neck ring 21, for example, to then separate the terminal end side of the coating layer 60 from the neck ring 21 for tearing off the covering layer 60 along the linear easy tear portion 70 while picking the separated terminal end side with fingers, whereby it is possible to easily separate the container main body 10a and the covering layer 60.

Particularly, at the shoulder portion 30 where the covering layer 60 tends to be thicker than the body portion 40, it is difficult to tear off the covering layer 60 from the lower surface of the neck ring 21 to the body portion 40 even if the end portion of the covering layer 60 is held with fingers. However, in the present embodiment, the easy tear portion 70 is provided from the lower surface of the neck ring 21 to the shoulder portion 30 of the container 10 where the covering layer 60 tends to be relatively thicker, whereby it is possible to easily tear off the covering layer 60 along the easy tear portion 70 and remove the covering layer 60 from the container main body 10a.

Considering this aspect, it is preferable to design the easy tear portion 7 of the multiple preform 1 such that the width of the easy tear portion 70 formed on the container 10 after blow molding is in a range of 0.1 to 2 mm. In this manner, it is possible to easily tear off the covering layer 60 of the molded container 10 by hand and suitably prevent the deterioration of the functions of the covering layer 60 due to the easy tear portion 70.

Moreover, when slitting is made on the covering layer 60 after molding the container 10 in order to facilitate the removal of the covering layer 60, the container main body 10a may be damaged. However, in the embodiment of the present invention, such damage does not occur in the container main body 10a.

Such a multiple preform 1 can be manufactured by a so-called double mold molding method.

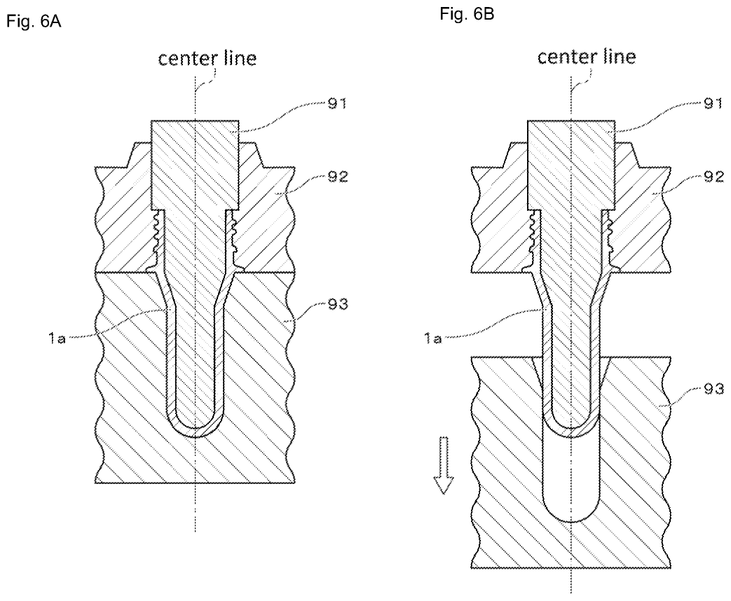

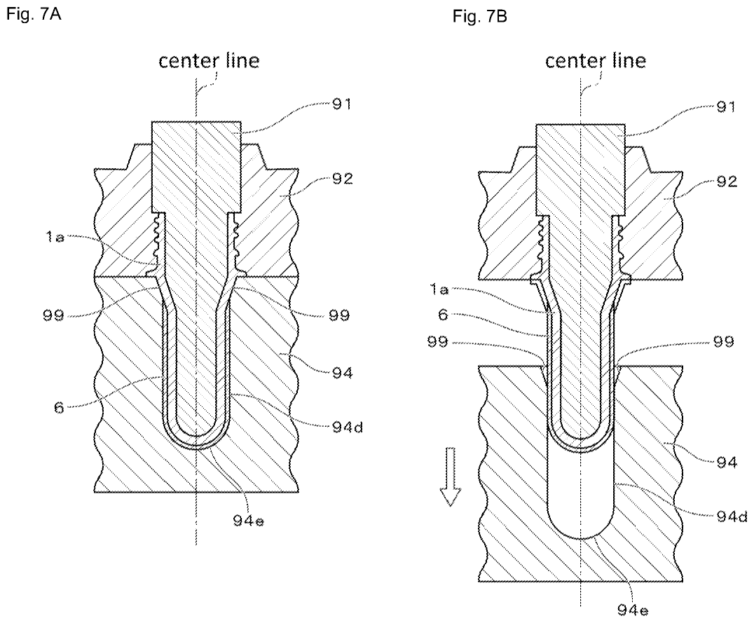

FIG. 6 and FIG. 7 are explanatory diagrams schematically illustrating an injection molding method for producing the multiple preform 1 according to the present embodiment, and illustrate a cross-section surface corresponding to the A-A section of FIG. 2.

To mold the preform main body 1a, there is used a primary molding mold that comprises a core mold 91 for molding the inner surface side of the preform main body 1a and the upper end surface of the mouth portion 2, a mouth portion mold 92 for molding the outer surface side of the mouth portion 2 including the upper surface and the peripheral end surface of the neck ring 21, and a first body portion mold 93 for molding the outer surface side of the preform main body 1a which is from the lower surface of the neck ring 21 to the bottom portion 4. The first body portion mold 93 is provided with a taper such that the inner periphery is expanded toward the neck ring side, at a position corresponding to the lower side of the neck ring 21 of the preform main body 1a, that is, the upper side of the body portion 3.

Such mold tool is clamped and filled with first thermoplastic resin forming the preform main body, thereby injection molding the preform main body 1a with the taper portion 3a expanding toward the neck ring 21 on the lower side of the neck ring 21 (primary injection) (FIG. 6(a)).

Then, to also use the core mold 91 and the mouth portion mold 92 as common molds in the next molding step (secondary injection), the molds are opened so as to separate the core mold 91 and the mouth portion mold 92 together with the preform main body 1a from the first body portion mold 93 (FIG. 6(b)).

Next, the core mold 91 and the mouth portion mold 92 together with the preform main body 1a are moved to an injection device used in the secondary injection. The preform main body 1a molded in the primary injection is inserted into a secondary molding mold to be clamped, and the secondary molding mold is filled with secondary thermoplastic resin, thereby injection molding the covering layer 6 (secondary injection) (FIG. 7(a)).

As the secondary molding mold of the present embodiment, there is used, in addition to the core mold 91 and the mouth portion mold 92 used also as the primary molding mold, a second body portion mold 94. The second body portion mold 94 has a gap from the preform main body 1a for the thickness of the covering layer 6, at a region from the peripheral edge of the neck ring 21 lower surface to the bottom portion 4 of the molded preform main body 1a, and has an inner peripheral surface to mold the outer side surface of the covering layer 6.

The second body portion mold 94 used in the present embodiment has an inner surface including a neck ring side wall 94a and a neck ring lower side annular surface 94b for forming the covering layer 6 on the lower surface of the neck ring 21 of the preform main body 1a, a taper surface 94c for forming the covering layer 6 on the taper portion 3a of the preform main body 1a, a body portion surface 94d for forming the covering layer 6 on the body portion 3 without a taper of the preform main body 1a, and a bottom portion surface 94e for forming the covering layer 6 on the outer surface of the bottom portion 4 of the preform main body 1a.

The taper surface 94c is provided with a taper such that the inner periphery expands toward the neck ring lower side annular surface 94b with the substantially same angle as the angle of the taper provided in the first body portion mold 93 used in the primary injection.

On the neck ring lower side annular surface 94b and the taper surface 94c, a projection strip portion 99 is formed in a gap where the covering layer 6 is formed. The projection strip portion 99 projects to be tapered toward the lower surface of the neck ring 21 and is in contact with the lower surface of the neck ring, while projection strip portion 99 projects to be tapered toward the body portion 3 of the preform main body 1a and extends along the axis direction. Such a projection strip portion 99 is provided in a range including the neck ring 21 lower surface of the preform main body 1a and a region immediately below the neck ring 21. In the illustrated example, the projection strip portion 99 is provided from the neck ring lower side annular surface 94b to a part of the taper surface 94c, but design can be appropriately performed depending on a shape of the container 10 after blow molding.

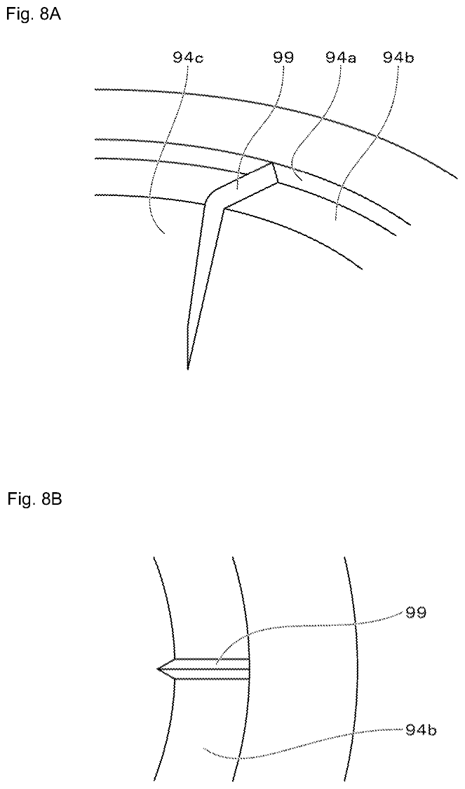

Note that FIG. 8 is an explanatory view illustrating, in an enlarged manner, a part of the second body portion mold 94 that the a secondary molding mold used for producing the multiple preform 1 according to the present embodiment, in which (a) is an enlarged perspective view of main part illustrating showing a portion where the projection strip portion 99 is formed on the body type 94 from the parting surface side with the a perspective view from the parting surface side, and (b) is a plan view illustrating the parting surface side of the body portion mold, and is an enlarged plan view of main part illustrating the parting surface side of the body portion mold in such a manner that the left side of the drawing corresponds to the inner side of the second body portion mold 94.

Here, it is preferable that the projection strip portion 99 is formed to be in contact with the lower surface of the neck ring 21 and the body portion 3 side of the preform main body 1a, so that the easy tear portion 7 is formed to have a slit shape. However, to prevent damage to the preform main body 1a after clamping the mold, the projection strip portion 99 may be formed so as to secure a slight clearance from the preform main body 1a. That is, the projection strip portion 99 may be formed to be adjacent to the lower surface of the neck ring 21 and to the body portion side of the preform main body 1a.

In this case, the resin injected into the mold enters between the preform main body 1a and the projection strip portion 99, thereby forming the easy tear portion 7 as a region with a small thickness. It is sufficient that the covering layer 60 can be easily teared apart in the blow-molded container 10.

Therefore, the concrete shape of the projection strip portion 99 and the like can be appropriately designed depending on a shape of the container 10 such that the covering layer 60 can be easily teared apart along the easy tear portion 70 in the blow-molded container 10.

However, considering the mold opening described later, the projection strip portion 99 of the present embodiment is designed not to project to the inner side of the mold tool than the inner peripheral surface defined by the body portion surface 94d without a taper. In the illustrated example, the projection strip portion 99 positioned on the lower side of the taper surface 94c is provided such that the tip end of the projection strip part 99 tapered toward the preform main body 1a side is positioned on the same surface as the inner peripheral surface of the body portion surface 94d in a range where such a tip end projects to the inner side of the body portion mold 94 than the inner peripheral surface of the body portion surface 94d when the tip end of the projection strip portion 99 is provided to be in contact with the preform main body 1a. This can avoid an undercut shape of the projection strip portion 99.

In this manner, it is possible to mold the covering layer 6 which covers, with the terminal end side thereof, the lower surface of the neck ring and reaches the peripheral edge of the neck ring, and which is provided with the easy tear portion 7.

Thereafter, the molds are opened (FIG. 7(b)), and the multiple preform 1 is completed.

With the use of the above-described second body portion mold 94 having the body portion surface 94d with the taper and the projection strip portion 99, it is possible to take out a molded article from the mold tool without causing an undercut shape even when the second body portion mold 94 is moved in the preform axis direction and opened.

Each of the preform main body 1a and the covering layer 6 can be molded using an arbitrary thermoplastic resin which allows blow molding. However, considering recyclability, it is preferable to use an ethylene terephthalate-based thermoplastic polyester such as polyethylene terephthalate as the first thermoplastic resin for forming the preform main body 1a.

Meanwhile, it is preferable to use a thermoplastic resin incompatible with the thermoplastic resin forming the preform main body 1a as the second thermoplastic resin for forming the covering layer 6. In this manner, it is possible to appropriately adjust the bonding strength (peeling strength) between the container main body 10a and the covering layer 60 depending on the degree of incompatibility so that the covering layer 60 can be more easily peeled off from the container main body 10a in the container 10 formed by blow molding the multiple preform 1.

Moreover, when an ethylene terephthalate-based thermoplastic polyester is used as the first thermoplastic resin for forming the preform main body 1a, it is preferable to use, as the second thermoplastic resin for forming the covering layer 6, a polyolefin-based resin such as polyethylene or polypropylene, ethylene-vinyl alcohol copolymer, polyamide-based resin such as polymethaxylylene adipamide (MXD6), and the like, for example. With the use of such resin, it is possible to improve the shareability of the covering layer 60.

Moreover, a pigment, a coloring agent, or the like may be added to the second thermoplastic resin for forming the covering layer 6 so that the covering layer 60 is colored in a desired hue. Various kinds of additive agents may be added if necessary without any restriction due to the recyclability required for the container main body 10a.

### Second Embodiment

The following describes the second embodiment of the present invention.

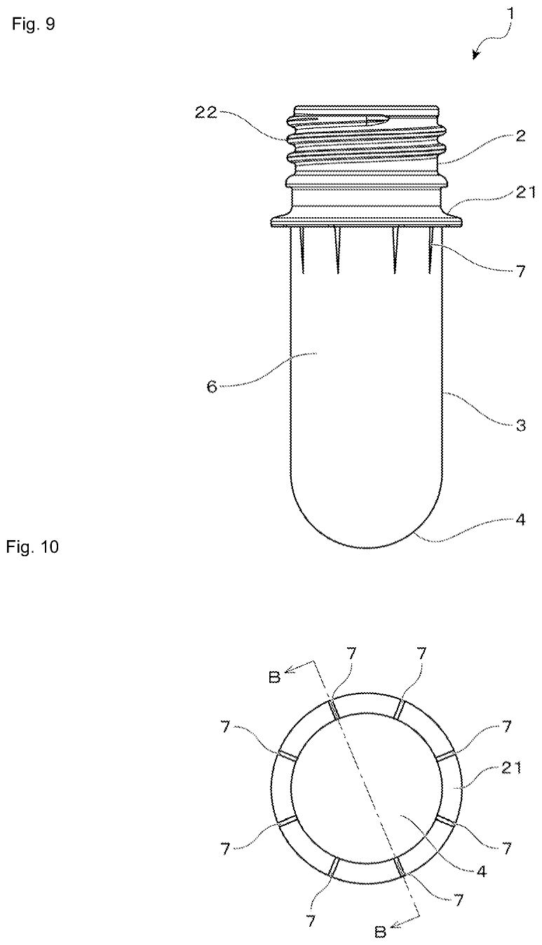

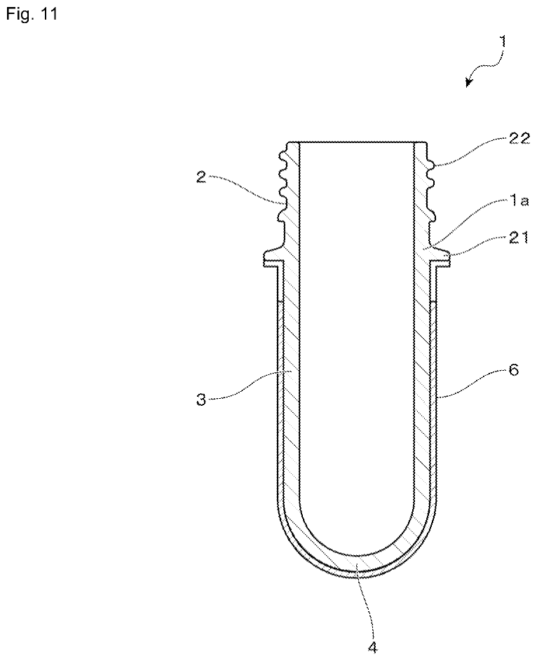

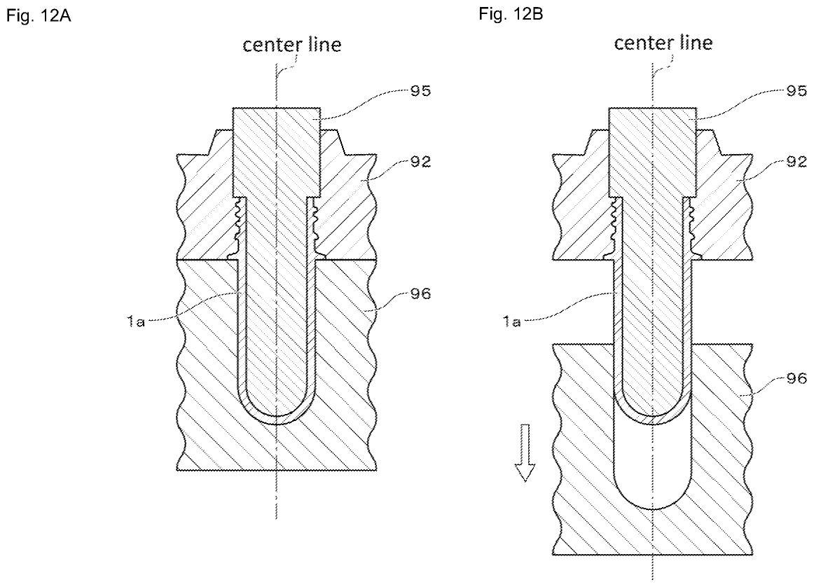

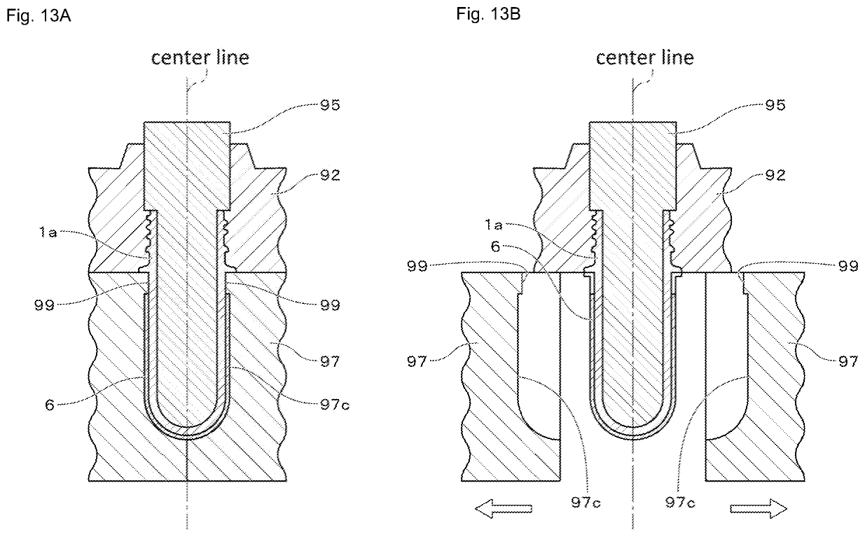

FIG. 9 is a front view schematically illustrating the multiple preform 1 according to the present embodiment. FIG. 10 is a bottom view schematically illustrating the second embodiment of the multiple preform according to the present invention, and FIG. 11 is a section view along line B-B of FIG. 10. FIG. 12 and FIG. 13 are explanatory views schematically illustrating an injection molding method for producing the multiple preform 1 according to the present embodiment, and illustrate a section corresponding to the B-B section of FIG. 11.

In the above-described first embodiment, the multiple preform 1 has a configuration in which the body portion 3 thereof has the taper portion 3a expanding in diameter toward the neck ring 21.

Meanwhile, the present embodiment is different from the first embodiment in that the body portion 3 of the multiple preform 1 is not provided with a taper.

In the present embodiment, the preform main body 1a is manufactured in the same manner as in the first embodiment except that in manufacturing the multiple preform 1 by the double mold molding method as described above, there is used, as the primary molding mold, the mouth portion mold 92 same as the first embodiment, and a core mold 95 and a third body portion mold 96 that are processed in the same manner as with the first body portion mold except that a taper is not provided at a position corresponding to the body portion 3 (primary injection) (FIG. 12(a)).

Then, the molds are opened in the same manner as in the first embodiment (FIG. 12(b)). Next, the core mold 95 and the mouth portion mold 92 together with the preform main body 1a are moved to an injection device used in the secondary injection, and the covering layer 6 can be formed by injection molding in the same manner as in the first embodiment except that a fourth body portion mold 97 is used in addition to the core mold 95 and the mouth portion mold 92 used also as the primary molding mold as the secondary molding mold of the present embodiment (secondary injection) (FIG. 13(a)).

Differing from the first embodiment, the fourth body portion mold 97 is a split mold that is split on a virtual plane surface including a center line of the multiple preform 1. The example in the drawing illustrates the embodiment in which the fourth body portion mold 97 is split to two moving from the center line of the multiple preform 1 toward the direction where the projection strip portion 99 is provided. However, the split position, the split direction, and the number of splitting can be appropriately set not to cause an undercut shape when the molds are opened, depending on the shape and the number of projection strip portions 99 provided in the body portion mold for forming the easy tear portion 7.

Moreover, differing from the first embodiment, the inner surface shape of the fourth body portion mold 97 in that a body portion surface 97c for forming the covering layer 6 on the outer surface of the preform main body 1a body portion 3 is not provided with a taper. In relation with this, configuration is not limited to that of the first embodiment in which the projection strip portion 99 is provided not to project to the inner side of the metal mold than the inner peripheral surface of the body portion surface without a taper, and it is sufficient that the tip end of the projection strip portion 99 is positioned at a height in contact with or adjacent to the preform main body 1a.

The fourth body portion mold 97 is different from the second body portion mold 94 in the above-described configuration, but may be similar to the second body portion mold 94 in other configurations.

Thereafter, the molds are opened, and the multiple preform 1 is completed (FIG. 13(b)). With the above-described configuration of the fourth body portion mold 97, the fourth body portion mold 97 is split moving from the center line of the multiple preform 1 toward the direction in which the projection strip portion 99 is provided.

In this manner, with the use of the fourth body portion mold 97 that is a split mold in the secondary step, it is possible to take out the multiple preform 1 from the mold tool without causing an undercut shape due to the projection strip portion 99 even when the body portion 3 is not provided with a taper.

The present embodiment is different from the first embodiment in the above-described aspect, but is similar to the first embodiment in other configurations, and thus repeated explanation will be omitted.

### Third Embodiment

The following describes the third embodiment of the present invention.

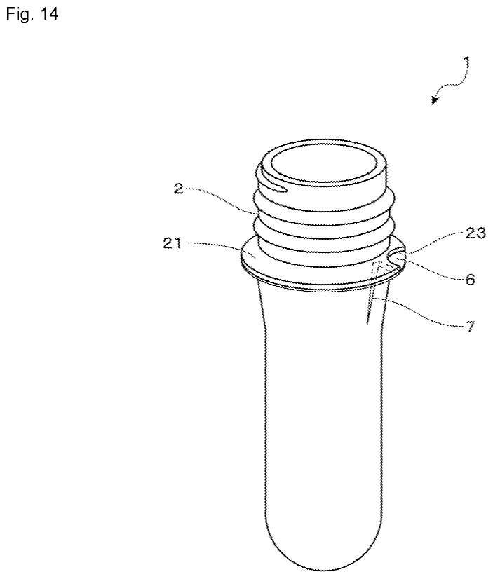

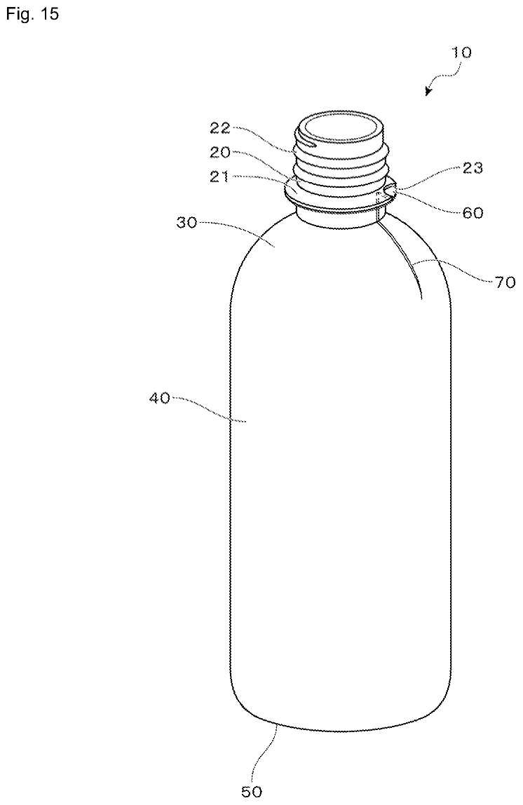

FIG. 14 is a perspective view schematically illustrating the multiple preform 1 according to the present embodiment, and FIG. 15 is a perspective view schematically illustrating an example of the synthetic resin container 10 formed by blow molding the multiple preform 1 illustrated in FIG. 14.

The present embodiment is different from the above-described first embodiment in that the preform main body 1a is molded to have a cut-out portion 23 where the covering layer 6 covering the lower surface of the neck ring 21 is exposed. The cut-out portion is formed on the peripheral edge side of the neck ring 21 of the multiple preform 1, corresponding to the position where the easy tear portion 7.

As described above, in blow molding the multiple preform 1, the mouth portion 2 including the neck ring 21 becomes the mouth portion 20 of the container 10 as is without being stretched.

Thus, when the neck ring 21 of the multiple preform 1 is provided in the above-described manner, the neck ring 21 of the container 10 is similarly provided with the cut-out portion 23 where the covering layer 60 covering the lower surface of the neck ring 21 is exposed, on the peripheral edge side of the neck ring 21.

In this manner, when the container 10 of which the contents have been consumed to the end is disposed, it is possible to easily pick, with fingers, the terminal end side of the covering layer 60 exposed from the cut-out portion 23 provided at the neck ring 21.

In the illustrated example, the cut-out portion 23 is provided by cutting out the outer peripheral edge side of the neck ring 21 in a half-moon shape. However, the shape of the cut-out portion 23 provided at the neck ring 21 is not particularly limited as long as the covering layer 60 covering the lower surface of the neck ring 21 is exposed and the terminal end side of the covering layer 60 can be picked with fingers.

In a case where the neck ring 21 is provided with the cut-out portion in this manner, the easy tear portion 7 is provided from the end of the cut-out portion 23 to a part of the body portion 3 of the multiple preform 1 in a range including the lower surface of the neck ring and a region immediately below the neck ring. In the illustrated example, the easy tear portion 7 is provided from one end of the cut-out portion 23 toward the body portion 3. However, the easy tear portion 7 may be provided from both ends of the cut-out portion 23.

In this manner, when the container 10 of which the contents have been consumed to the end is disposed, the terminal end side of the covering layer 60 which is exposed from the cut-out portion 23 provided at the neck ring 21 is picked with fingers to tear off the covering layer 60 from the picked side along the easy tear portion 70 provided toward the container shoulder portion 30, whereby it is possible to easily separate the container main body 10a and the covering layer 60.

Moreover, in the present embodiment, in manufacturing the multiple preform 1 by the double mold molding method as described above, it is possible to manufacture the multiple preform 1 in the same manner in as the first embodiment, except that there is used the mouth portion mold 92 processed such that the neck ring 21 is provided with the cut-out portion 23 by arranging a projection at a position corresponding to the cut-out portion 23 provided on the peripheral edge side of the neck ring 21, for example.

The present embodiment is different from the first embodiment in the above-described aspect, but is similar in other configurations as in the first embodiment, and thus repeated explanation will be omitted.

### Fourth Embodiment

The following describes the fourth embodiment of the present invention.

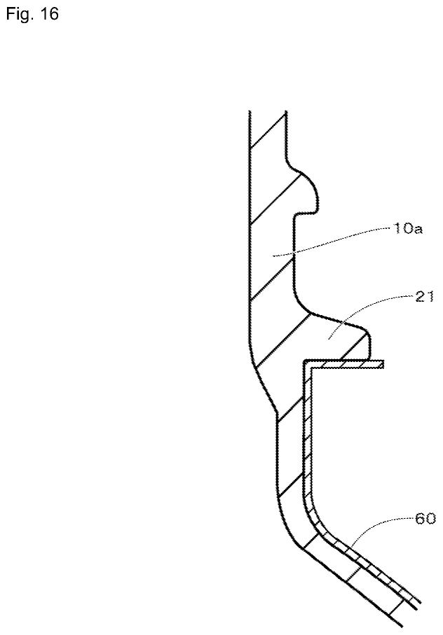

FIG. 16 is an enlarged section view of main part schematically illustrating the synthetic resin container 10 according to the present embodiment, and illustrates, in an enlarged manner, a section of the vicinity of the neck ring of the container 10, similarly to FIG. 5.

The present embodiment is different from the above-described first embodiment in such a configuration that at least a part of the terminal end side of the covering layer 6 of the multiple preform 1 is provided to project from the peripheral edge of the neck ring 21, corresponding to the position where the easy tear portion 7 is formed.

As described above, in blow molding the multiple preform 1, the mouth portion 2 including the neck ring 21 becomes the mouth portion 20 of the container 10 as is without being stretched, and the terminal end side of the covering layer 60 covering the lower surface of the neck ring 21 also remains as is.

Thus, when the covering layer 6 of the multiple preform 1 is provided in the above-described manner, the covering layer 60 of the container 10 formed by blow molding the multiple preform 1 is also provided such that at least a part of the terminal end side of the covering layer 60 projects from the peripheral edge of the neck ring 21.

In this manner, when the container 10 of which the contents have been consumed to the end is disposed, it is possible to easily pick, with fingers, the terminal end side of the covering layer 60 projecting from the peripheral edge of the neck ring 21.

In a case where the covering layer 6 is provided such that at least a part of the terminal end side of the covering layer 6 projects from the peripheral edge of the neck ring 21, it is preferable, from the viewpoint of tearing off the covering layer 60 of the container 10 from the container main body 10a, that the easy tear portion 7 is provided from the vicinity of where the terminal end side of the covering layer 6 projects from the peripheral edge of the neck ring 21 to a part of the body portion 3 of the multiple preform 1, in a range including the lower surface of the neck ring and a region immediately below the neck ring.

In this manner, when the container 10 of which the contents have been consumed to the end is disposed, the terminal end side of the covering layer 60 projecting from the peripheral edge of the neck ring 21 is picked with fingers to tear off the covering layer 60 from the picked side along the easy tear portion 70 provided toward the container shoulder portion 30, whereby it is possible to easily separate the container main body 10a and the covering layer 60.

When the covering layer 6 is formed in this manner, it is sufficient that at least a part of the terminal end side of the covering layer 6 is provided to project from the peripheral edge of the neck ring 21. However, it is also possible to provide the covering layer 6 such that the terminal end side thereof projects from the peripheral edge over the entire periphery of the neck ring 21.

Moreover, to arrange projection of the terminal end side of the covering layer 6 from the peripheral edge of the neck ring 21, it is preferable to appropriately adjust the projection length and the projection range so as not to prevent the projecting region from being picked with fingers while preventing the projecting region from being unintentionally caught by any object and damaged or being teared apart from the main body.

For example, it is possible to narrow a projection range by arranging a projection with a length allowing easy-picking of the covering layer 6 with fingers from the peripheral edge of the neck ring 21, in a range of one fourth of the circumferential direction of the neck ring 21.

In manufacturing such a multiple preform 1 by the double mold molding method as described above, it is possible to manufacture the multiple preform 1 in the same manner as in the first embodiment using the body portion mold of the secondary molding mold processed in the same manner as in the first embodiment except that the barrel body portion mold of the secondary molding mold is formed so as to project at least a part of the terminal end side of the covering layer 6 from the peripheral edge of the neck ring of the preform main body 1a.

As described above, in the present embodiment, when the container 10 with the covering layer covering a region except a part of the mouth portion side, of which the contents have been consumed to the end is disposed, the covering layer 60 is easily teared apart from the container main body 10a along the easy tear portion 70 with the terminal end side of the covering layer 60 in the vicinity of the peripheral edge of the neck ring 21 as a start point, whereby it is possible to easily separate the container main body 10a and the covering layer 60.

The present invention has been described using the preferred embodiments. However, the present invention is not limited to only the above-described embodiments, and it is obvious that various changes can be made within the scope of the present invention.

For example, the multiple preform 1 may be manufactured by combining the above-described first embodiment, second embodiment, third embodiment, and fourth embodiment.

Moreover, regarding the third embodiment and the fourth embodiment, the body portion 3 of the multiple preform 1 does not need to be provided with a taper by using a body portion mold that is a split mold as in the second embodiment, in the secondary injection for manufacturing the multiple preform 1.

Moreover, in the described embodiments, the easy tear portion 7 is provided linearly in the preform axis direction. However, in a case where a body portion mold that is a split mold is used in the secondary step to mold the multiple preform 1, the easy tear portion 7 does not need to be provided linearly in the axis direction as long as an undercut shape is not caused.

Moreover, a tear-off perforation or the like may be further formed on the covering layer 60 by a CO₂ laser or the like.

### REFERENCE SIGNS LIST

1 multiple preform
1a preform main body
2 mouth portion
3 body portion
4 bottom portion
6 covering layer
7 easy tear portion
10 synthetic resin container
10a container main body
20 mouth portion
21 neck ring
22 screw thread
23 cut-out portion
30 shoulder portion
40 body portion
50 bottom portion
60 covering layer
70 easy tear portion

1. A method for producing a multiple preform for blow molding a synthetic resin container with a covering layer, the method comprising:
a primary injection for injection molding, using a primary molding mold, a preform main body that is formed to have a bottomed cylindrical shape including a mouth portion, a body portion, and a bottom portion, and that includes a neck ring annularly projecting along a circumferential direction on a lower end side of the mouth portion; and
a secondary injection for injection molding, using a secondary molding mold, a covering layer that covers the preform main body such that a terminal end side of the covering layer covers a lower surface of the neck ring and reaches a peripheral edge of the neck ring,
wherein
a projection strip portion that is formed between the preform main body and an inner peripheral surface of the secondary molding mold when the preform main body molded in the primary injection is inserted into the secondary mold to be clamped, that projects in a gap in which the covering layer is molded to be in contact with or adjacent to a lower surface of the neck ring, and that extends with a given length along an axis direction, is formed on an inner peripheral surface of the secondary molding mold, thereby forming an easy tear portion in the covering layer molded in the secondary injection.

2. The method for producing a multiple preform according to claim 1, wherein
the preform main body is molded to have a taper portion expanding in diameter toward the neck ring, on a lower side of the neck ring, and
the projection strip portion is formed at a position corresponding to the taper portion of the inner peripheral surface of the secondary molding mold,
thereby forming the easy tear portion at a part of the covering layer covering the taper portion.

3. The method for producing a multiple preform according to claim 1, wherein the preform main body is molded to have a cut-out portion at which the covering layer covering the neck ring lower surface is exposed on a peripheral edge side of the neck ring, corresponding to a position at which the easy tear portion is formed.

4. A synthetic resin container, comprising:
a mouth portion;
a body portion; and
a bottom portion, wherein
the synthetic resin container includes a neck ring that annularly projects along a circumferential direction on a lower end side of the mouth portion, and a covering layer that covers a region except a part of the mouth portion side such that a terminal end side of the covering layer covers a lower surface of the neck ring and reaches a peripheral edge of the neck ring, and
an easy tear portion extending along an axis direction is formed in a range including the lower surface of the neck ring and a region immediately below the neck ring.

5. The method for producing a multiple preform according to claim 2, wherein the preform main body is molded to have a cut-out portion at which the covering layer covering the neck ring lower surface is exposed on a peripheral edge side of the neck ring, corresponding to a position at which the easy tear portion is formed.
